(19) United States
(12) Patent Application Publication
(10) Pub. No.: US 2025/0168920 A1
(43) Pub. Date: May 22, 2025

(54) METHOD AND USER EQUIPMENT FOR PERFORMING SYNCHRONIZATION WITH NETWORK NODE

(71) Applicant: Samsung Electronics Co., Ltd., Suwon-si, Gyeonggi-do (KR)

(72) Inventor: Vinay Kumar SHRIVASTAVA, Bangalore (IN)

(21) Appl. No.: 18/837,747

(22) PCT Filed: Feb. 14, 2023
(86) PCT No.: PCT/KR2023/002110

§ 371 Date: Aug. 12, 2024

(30) Foreign Application Priority Data
Feb. 14, 2022 (IN) 202241007634
Jan. 25, 2023 (IN) 2022 41007634

(51) Int. Cl. H04W 76/27; H04W 56/00

(52) U.S. Cl. CPC H04W 76/27; H04W 56/0015

(57) ABSTRACT

The disclosure relates to a 5G or 6G communication system for supporting a higher data transmission rate. Embodiments herein disclose a method performed by a user equipment (UE) in a communication system. The method may include detecting a transition of the UE from a CONNECTED state to an IDLE state or an INACTIVE state, determining, whether the UE is configured or capable to receive a tracking reference signal (TRS) configuration from the network node in case that the UE transitions from the CONNECTED state to the IDLE state or the INACTIVE state, and receiving a system information block x (SIBx) message including the TRS configuration that is broadcasted by the network node and synchronizing with the network node by utilizing the TRS configuration in case that the UE is configured or capable to receive the TRS configuration from the network node in the IDLE state or the INACTIVE state.

### TECHNICAL FIELD

The disclosure relates to a wireless communication system, and more particularly to a method and user equipment for performing synchronization with a network node.

### BACKGROUND ART

5G mobile communication technologies define broad frequency bands such that high transmission rates and new services are possible, and can be implemented not only in “Sub 6GHZ” bands such as 3.5GHZ, but also in “Above 6GHZ” bands referred to as mmWave including 28GHz and 39GHz. In addition, it has been considered to implement 6G mobile communication technologies (referred to as Beyond 5G systems) in terahertz bands (for example, 95GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The embodiments of the disclosure may provide a method and a User Equipment (UE) for performing synchronization of the UE with a network node, and the proposed method handles large size configuration message of a reference signal for synchronization.

The embodiments of the disclosure may provide a method and a device to receive a New System Information Block (SIBx) message including a Track Reference Signal (TRS) configuration that is broadcasted by the network node, and the UE synchronizes with the network node by utilizing the TRS configuration.

The embodiments of the disclosure may provide a method and system for delivering and receiving the segments for the SIBx message segmentation scenario.

The embodiments of the disclosure may provide a method and a device to synchronize the UE with the network node during an IDLE state or in an INACTIVE state of the UE when the availability status for the TRS configuration is present and a validity duration of the TRS configuration is not elapsed.

The embodiments of the disclosure may provide a method and a device to store a SIBx segment of the SIBx message in a storage when the SIBx segment is not associated with a previous SIBx based on a tag value of the SIBx present in a SIBI and assemble segments of the SIBx message when all the segments of the SIBx message are received in the storage.

The embodiments of the disclosure may provide a method and a device to discard the stored SIBx segments when a cell selection or a cell reselection is to the target cell that is different than that of a serving cell.

The embodiments of the disclosure may provide a method and a device to discard the stored SIBx segments when the cell selection or the cell reselection is to the target cell whose area scope is not different than the area scope of the serving cell.

### SOLUTION TO PROBLEM

Accordingly, the embodiments herein disclose a method for performing synchronization of a User Equipment (UE) with a network node, the method includes detecting, by the UE, a transition of the UE from a CONNECTED state to an IDLE state or an INACTIVE state. The method further includes determining, by the UE, whether the UE is configured or capable to receive a Tracking Reference Signal (TRS) configuration from the network node when the UE transitions from the CONNECTED state to the IDLE state or the INACTIVE state. The method further includes synchronizing with the network node by utilizing a Secondary Synchronization Block (SSB) when the UE is not configured or not capable to receive the TRS configuration from the network node in the IDLE state or the INACTIVE state. The method further includes receiving, by the UE, a New System Information Block (SIBx) message including the TRS configuration that is broadcasted by the network node and synchronizing with the network node by utilizing the TRS configuration when the UE is configured or capable to receive the TRS configuration from the network node in the IDLE state or the INACTIVE state.

In an embodiment, the method includes storing, by the UE, the SIBx message that is received by the UE. The method further includes determining, by the UE, whether an availability indication for the TRS configuration is present and a validity duration of the TRS configuration is not elapsed using the SIBx message. The method further includes synchronizing, by the UE, with the network node in the at least one of the IDLE state and the INACTIVE state when the availability status for the TRS configuration is present and the validity duration of the TRS configuration is not elapsed.

In an embodiment, the method includes receiving, by the UE, a System Information Block (SIB1) that is broadcasted by the network node. The method further includes determining, by the UE, whether a schedule information indication of SIBx message is present in the SIB1. The method further includes determining the SIBx message from the network node when the schedule information indication of the SIBx message is present in the SIB1; and synchronizing with the network node by utilizing the TRS configuration in the SIBx message. The method further includes synchronizing with the network node by utilizing the SSB when the schedule information indication of the SIBx message is not present in the SIB1.

In an embodiment, the method includes demanding at least one of the SIBx message and the SIBx segments from the network node when the schedule information indication is not present in the SIB1. The method further includes accessing at least one of the SIBx message and the SIBx segments when the schedule information indication is present in the SIB1.

In an embodiment, the method includes receiving, by the UE, a segment of the SIBx message from the broadcast of the network node; wherein the segment of the SIBx message includes a part of the SIBx message; wherein a tag value of the SIBx is present in the SIB1. The method further includes determining, by the UE, whether the SIBx segment is associated with a previous SIBx based on the tag value of the SIBx present in the SIB1. The method further includes discarding stored SIBx segments when the SIBx segment is associated with the previous SIBx based on the tag value of the SIBx present in the SIB1. The method further includes storing the SIBx segment of the SIBx message in a storage when the SIBx segment is not associated with the previous SIBx based on the tag value of the SIBx present in the SIB1. The method further includes determining whether all segments of the SIBx message are received in the storage and assembling the all segments of the SIBx message when all segments of the SIBx message are received in the storage.

In an embodiment, the method includes determining, by the UE, an occurrence of a cell selection or a cell reselection. The method further includes determining, by the UE, whether the cell selection or the cell reselection is to a target cell that is different than that of a serving cell. The method further includes discarding, by the UE, the stored SIBx segments when the cell selection or the cell reselection is to the target cell that is different than that of a serving cell.

In an embodiment, the method includes determining, by the UE, whether the cell selection or the cell reselection is to a target cell whose area scope is different than the area scope of the serving cell. The method further includes discarding the stored SIBx segments when the cell selection or the cell reselection is to the target cell whose area scope is different than the area scope of the serving cell. The method further includes keeping the stored SIBx segments when the cell selection or the cell reselection is to the target cell whose area scope is not different than the area scope of the serving cell. The method further includes discarding the stored SIBx segments when the target cell is not supporting the TRS configuration or the schedule information for the SIBx is not present in the SIBI when the cell selection or the cell reselection is to the target cell whose area scope is not different than the area scope of the serving cell.

In an embodiment, the method includes determining, by the UE, a change in the IDLE state of the UE. The method further includes initiating, by the UE, a Radio Resource Control (RRC) connection by sending a RRC setup request to the network node. The method further includes receiving, by the UE, a connection setup message in response to the RRC setup request. The method further includes transiting, by the UE, to the CONNECTED state from the IDLE state using the connection setup message. The method further includes discarding, by the UE, the stored SIBx segments when the UE transits state to the CONNECTED state from the IDLE state.

In an embodiment, the method includes determining, by the UE, a change in the INACTIVE state of the UE. The method further includes resuming, by the UE, the Radio Resource Control (RRC) connection by sending a RRC resume request to the network node. The method further includes receiving, by the UE, a RRC resume message in response to the RRC resume request. The method further includes transiting, by the UE, to the CONNECTED state from the INACTIVE state using the RRC resume message. The method further includes discarding, by the UE, the stored SIBx segments when the UE transits state to the CONNECTED state from the INACTIVE state.

In an embodiment, the method includes detecting, by the UE, whether any transition of the UE to the CONNECTED state from one of the INACTIVE state or IDLE state. The method further includes performing, by the UE, one of stop accessing or stop receiving SIBx segments in the CONNECTED state when any transition of the UE to the CONNECTED state from one of the INACTIVE state or IDLE state.

In an embodiment, synchronization of the UE with the network node includes at least one of time synchronization, frequency synchronization, gain synchronization and Radio resource management (RRM) measurements.

In an embodiment, the UE performs one of: discards the stored SIBx segments or discontinues using the TRS configuration in the received SIBx message when at least one of the availability indication for the TRS configuration is unavailable and the validity duration of the TRS configuration is elapsed.

In an embodiment, the method includes determining, by the network node, a size of the TRS configuration and identifying, by the network node, whether the size of the TRS configuration meets a threshold. The method further includes segmenting the TRS configuration when the size of the TRS configuration meets the threshold. The method further includes sending the TRS configuration in the SIBx message without segmenting the TRS configuration when the size of the TRS configuration does not meet the threshold.

In an embodiment, the method includes fitting, by the network node, a first portion of the TRS configuration and an identifier of the first portion of the TRS configuration in a first segment of the SIBx message. The method further includes fitting, by the network node, at least one second portion of the TRS configuration and a identifier of the at least one second portion of the TRS configuration in the at least one second segment of the SIBx message; wherein the identifier helps the UE to identify a last segment of the SIBx message.

In an embodiment, the method includes fitting the TRS configuration without an identifier in the SIBx message. The method further includes fitting the TRS configuration and a key identifier in the SIBx message; wherein the key identifier indicates that the SIBx message is without segmentation.

Accordingly, the embodiments herein disclose the UE for performing synchronization of the UE with the network node, wherein the UE includes: a memory, a processor coupled to the memory; and a synchronizing controller coupled to the memory and the processor, and configured to: detect the transition of the UE from the CONNECTED state to the IDLE state or the INACTIVE state. The synchronizing controller is configured to determine whether the UE is configured or capable to receive the TRS configuration from the network node when the UE transitions from the CONNECTED state to the IDLE state or the INACTIVE state. The synchronizing controller is further configured to synchronize with the network node by utilizing the SSB when the UE is not configured or not capable to receive the TRS configuration from the network node in the IDLE state or the INACTIVE state. The synchronizing controller is further configured receive the SIBx message including the TRS configuration that is broadcasted by the network node and synchronize with the network node by utilizing the TRS configuration when the UE is configured or capable to receive the TRS configuration from the network node in the IDLE state or the INACTIVE state.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein and the embodiments herein include all such modifications.

### ADVANTAGEOUS EFFECTS OF INVENTION

The embodiments of the disclosure may provide a method and a User Equipment (UE) for performing synchronization of the UE with a network node, and the proposed method handles large size configuration message of a reference signal for synchronization.

The embodiments of the disclosure may provide a method and a device to receive a New System Information Block (SIBx) message including a Track Reference Signal (TRS) configuration that is broadcasted by the network node, and the UE synchronizes with the network node by utilizing the TRS configuration.

The embodiments of the disclosure may provide a method and system for delivering and receiving the segments for the SIBx message segmentation scenario.

The embodiments of the disclosure may provide a method and a device to synchronize the UE with the network node during an IDLE state or in an INACTIVE state of the UE when the availability status for the TRS configuration is present and a validity duration of the TRS configuration is not elapsed.

The embodiments of the disclosure may provide a method and a device to store a SIBx segment of the SIBx message in a storage when the SIBx segment is not associated with a previous SIBx based on a tag value of the SIBx present in a SIBI and assemble segments of the SIBx message when all the segments of the SIBx message are received in the storage.

The embodiments of the disclosure may provide a method and a device to discard the stored SIBx segments when a cell selection or a cell reselection is to the target cell that is different than that of a serving cell.

The embodiments of the disclosure may provide a method and a device to discard the stored SIBx segments when the cell selection or the cell reselection is to the target cell whose area scope is not different than the area scope of the serving cell.

### BRIEF DESCRIPTION OF DRAWINGS

This disclosure is illustrated in the accompanying drawings, throughout which like reference letters indicate corresponding parts in the various figures. The embodiments herein will be better understood from the following description with reference to the drawings, in which:

FIG. 1 illustrates a block diagram of an User Equipment (UE) for performing synchronization with a network node, according to an embodiment as disclosed herein;

FIG. 2 is a flow chart illustrating a method for performing synchronization of the UE with the network node, according to an embodiment as disclosed herein;

FIG. 3 is a flow chart illustrating an overall process in synchronizing the UE with the network node, according to an embodiment as disclosed herein;

FIG. 4A is a schematic diagram illustrating a segment of a SIBx message containing a octet string, according to an embodiment as disclosed herein;

FIG. 4B is a schematic diagram illustrating a segment of a SIBx message containing a octet string, according to an embodiment as disclosed herein;

FIG. 4C is a schematic diagram illustrating a segment of a SIBx message containing a octet string, according to an embodiment as disclosed herein;

FIG. 5A is a schematic diagram illustrating segment of the SIBx message containing a TRS configuration, according to an embodiment as disclosed herein;

FIG. 5B is a schematic diagram illustrating segment of the SIBx message containing a TRS configuration, according to an embodiment as disclosed herein;

FIG. 5C is a schematic diagram illustrating segment of the SIBx message containing a TRS configuration, according to an embodiment as disclosed herein;

FIG. 6 is a flow chart illustrating a method involved after transition of UE to a CONNECTED state from an IDLE state, according to an embodiment as disclosed herein;

FIG. 7 is a flow chart illustrating a method involved after transition of UE to the CONNECTED state from the INACTIVE state, according to an embodiment as disclosed herein;

FIG. 8 is a flow chart illustrating a method of discarding stored segments when determining a cell reselection, according to an embodiment as disclosed herein;

FIG. 9 is a flow chart illustrating a method of discarding the stored segments when determining the cell reselection is to a cell whose are scope is different than the area scope of the serving cell, according to an embodiment as disclosed herein;

FIG. 10 is a flow chart illustrating a method of assembling the SIBx message from the stored segments, according to an embodiment as disclosed herein;

FIG. 11 is an electronic device according to an embodiment as disclosed herein; and

FIG. 12 is an electronic device according to an embodiment as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The accompanying drawings are used to help easily understand various technical features and it should be understood that the embodiments presented herein are not limited by the accompanying drawings. As such, the disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

In wireless communication systems, essential system information is conveyed to a User Equipments (UEs) by broadcasting over the radio coverage by a network node as System Information Block (SIB). For power saving purpose of the UEs which are in an IDLE state or an INACTIVE state, the network node may reuse reference signals which are typically transmitted to CONNECTED state UEs. With the reference signals, UEs can perform at least one type of synchronization such as a time synchronization, a frequency synchronization, a gain synchronization or a Radio Resource Management (RRM) measurements which enables power saving for the UEs. However due to large number of configurations in the reference signal and also each configuration consisting of many parameters, the resultant size of the configuration information in the reference signal is huge and also exceeds the size of the SIB, which causes problems in handling the reference signal with the configuration.

Further, the conventional systems uses a Secondary Synchronization Block (SSB) for synchronization however the mis-alignment in the periodicity or occasions of the SSB with respect to paging occasion where IDLE/INACTIVE state UEs wakeup. Thus the SSB causes longer wakeup or more wakeup occasions which causes excessive power consumption.

Thus, it is desired to address the above mentioned disadvantages or other shortcomings or at least provide a useful alternative.

Accordingly, the embodiments herein disclose a method for performing synchronization of a User Equipment (UE) with a network node, the method includes detecting, by the UE, a transition of the UE from a CONNECTED state to an IDLE state or an INACTIVE state. The method further includes determining, by the UE, whether the UE is configured or capable to receive a Tracking Reference Signal (TRS) configuration from the network node when the UE transitions from the CONNECTED state to the IDLE state or the INACTIVE state. The method further includes synchronizing with the network node by utilizing a Secondary Synchronization Block (SSB) when the UE is not configured or not capable to receive the TRS configuration from the network node in the IDLE state or the INACTIVE state. The method further includes receiving, by the UE, a New System Information Block (SIBx) message including the TRS configuration that is broadcasted by the network node and synchronizing with the network node by utilizing the TRS configuration when the UE is configured or capable to receive the TRS configuration from the network node in the IDLE state or the INACTIVE state.

Accordingly, the embodiments herein disclose the UE for performing synchronization of the UE with the network node, wherein the UE includes: a memory, a processor coupled to the memory; and a synchronizing controller coupled to the memory and the processor, and configured to: detect the transition of the UE from the CONNECTED state to the IDLE state or the INACTIVE state. The synchronizing controller is configured to determine whether the UE is configured or capable to receive the TRS configuration from the network node when the UE transitions from the CONNECTED state to the IDLE state or the INACTIVE state. The synchronizing controller is further configured to synchronize with the network node by utilizing the SSB when the UE is not configured or not capable to receive the TRS configuration from the network node in the IDLE state or the INACTIVE state. The synchronizing controller is further configured to receive the SIBx message including the TRS configuration that is broadcasted by the network node and synchronize with the network node by utilizing the TRS configuration when the UE is configured or capable to receive the TRS configuration from the network node in the IDLE state or the INACTIVE state.

In wireless networks, essential system information is conveyed to the UE by broadcasting over the radio coverage such as over a cell or an area which can be multiple cells by the network node such as a base station and a next generation NodeB. The essential system information is transmitted as System Information Block (SIB). There are many SIBs defined as relevant to providing different types of system information. For power saving purpose of the UEs which are in the IDLE state or in the INACTIVE state, the network node may reuse the reference signals such as TRS/Channel State Information Reference Signal (CSIRS) for synchronization the UE with the network node. Further the reference signals are typically transmitted to the CONNECTED state of the UEs also for synchronization with the network node.

The UE may use the TRS reference signals to perform at least one of time synchronization, frequency synchronization, gain control/synchronization or Radio Resource Management (RRM) measurements more effectively than the legacy SSB based operations in IDLE state or INACTIVE state. This results in enabling power saving for the UEs. To enable power saving, TRS/CSIRS reference signals configuration is provided to the UEs. However, due to large number of configurations and also each configuration consisting of many parameters, the resultant size of the configuration information is huge and also exceeds the size of the SIB message. Thus transmitting and handling the SIB message with huge size is difficult.

Further there can be issues with the broadcasted SIB message carrying the TRS/CSIRS configuration for the UE power saving, for example issues with the validity of the SIB message. Further the validity of the SIB message is dependent on many different factors. Thus the SIB message cannot be used in UE when the SIB message is expired.

Unlike conventional system, in the proposed system the configuration information that is SIB message is splitted and provides to the UEs.

Unlike conventional system, the proposed system provides a method and system for the SIB message segmentation and handling in a 5G New Radio (NR) network.

Unlike conventional system, the proposed system provides a method and system for delivering and receiving the segments for the SIB message segmentation scenario.

Unlike conventional system, the proposed system provides a method and system for the Hybrid Automatic Repeat Retransmission (HARQ) operation for the SIB message segmentation scenario.

Unlike conventional system, the proposed system provides a method and system for performing storing, discarding and reordering operation for the SIB message segmentation scenario.

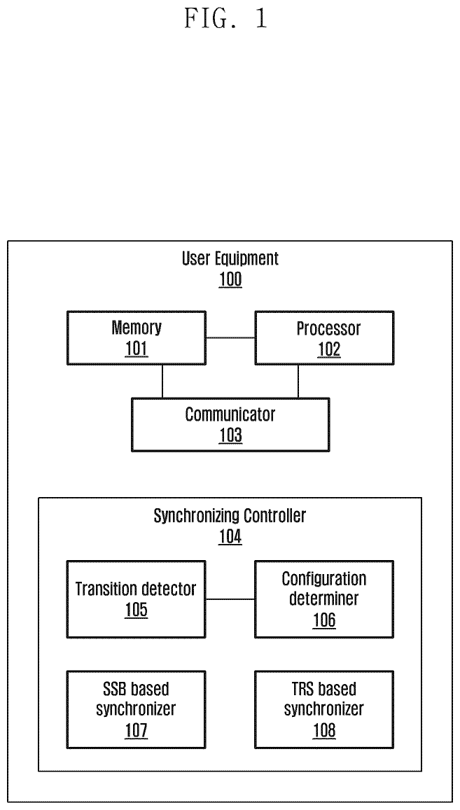

Referring now to the drawings and more particularly to FIGS. 1 through 12, where similar reference characters denote corresponding features consistently throughout the figure, these are shown preferred embodiments.

FIG. 1 illustrates an block diagram of an User Equipment (UE) (100) for performing synchronization with a network node, according to an embodiment as disclosed herein;

Referring to FIG. 1, examples of the UE (100) include but are not limited to a laptop, a palmtop, a desktop, a mobile phone, a smartphone, Personal Digital Assistant (PDA), a tablet, a wearable device, an Internet of Things (IOT) device, a virtual reality device, a foldable device, a flexible device, a connected car, an autonomous vehicle, a television, an immersive system, etc.

In an embodiment, the UE (100) includes a memory (101), a processor (102), a communicator (103) and a synchronizing controller (104).

The memory (101) stores instructions for authentication method selection to be executed by the processor (102). The memory (101) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (101) may, in some examples, be considered a non-transitory storage medium. The term “non-transitory” may indicate that the storage medium is not embodied in a carrier wave or a propagated signal. However, the term “non-transitory” should not be interpreted that the memory (101) is non-movable. In some examples, the memory (101) can be configured to store larger amounts of information than its storage space. In certain examples, a non-transitory storage medium may store data that can, over time, change (e.g., in Random Access Memory (101) (RAM) or cache). The memory (101) can be an internal storage unit or it can be an external storage unit of the alarm monitoring device (200), a cloud storage, or any other type of external storage.

In an embodiment, the RRC_CONNECTED state is mentioned as CONNECTED state. Further the RRC_IDLE state is mentioned as IDLE state. Further the RRC_INACTIVE state is mentioned as INACTIVE state.

The processor (102) is configured to execute instructions stored in the memory (101). The processor (102) may be a general-purpose processor (102), such as a Central Processing Unit (CPU), an Application Processor (AP), or the like, a graphics-only processing unit such as a Graphics Processing Unit (GPU), a Visual Processing Unit (VPU) and the like. The processor (102) may include multiple cores to execute the instructions.

The communicator (103) is configured for communicating internally between hardware components in the UE (100). Further, the communicator (103) is configured to facilitate the communication between the UE (100) and other devices via one or more networks (e.g. Radio technology). The communicator (103) includes an electronic circuit specific to a standard that enables wired or wireless communication.

The processor (102) is coupled with the synchronizing controller (104) to perform the embodiment. The synchronizing controller (104) includes a transition detector (105), a configuration determiner (106), a SSB based synchronizer (107) and a TRS based synchronizer (108).

The transition detector (105) detects a transition of the UE (100) from a

CONNECTED state to an IDLE state or an INACTIVE state or vice-versa. The configuration determiner (106) determines whether the UE (100) is configured or capable to receive a Tracking Reference Signal (TRS) configuration from the network node when the UE (100) transition from the CONNECTED state to the IDLE state or the INACTIVE state.

The SSB based synchronizer (107) synchronizes the UE (100) with the network node by utilizing a Secondary Synchronization Block (SSB) when the UE (100) is not configured or not capable to receive the TRS configuration from the network node in the IDLE state or the INACTIVE state.

The TRS based synchronizer (108) receives a New System Information Block (SIBx) message including the TRS configuration that is broadcasted by the network node and synchronize the UE (100) with the network node by utilizing the TRS configuration when the UE (100) is configured or capable to receive the TRS configuration from the network node in the IDLE state or the INACTIVE state.

The synchronizing controller (104) is configured to store the SIBx message that is received by the UE (100). The synchronizing controller (104) is further configured to determine whether an availability indication for the TRS configuration is present and a validity duration of the TRS configuration is not elapsed using the SIBx message. The synchronizing controller (104) is further configured to synchronize with the network node in the at least one of the IDLE state and the INACTIVE state when the availability status for the TRS configuration is present and the validity duration of the TRS configuration is not elapsed.

The synchronizing controller (104) is configured to receive a System Information Block (SIB1) that is broadcasted by the network node. The synchronizing controller (104) is further configured to determine whether the schedule information indication of SIBx message is present in the SIB1. The synchronizing controller (104) is further configured to determine the SIBx message from the network node when the schedule information indication of the SIBx message is present in the SIB1; and synchronizing with the network node by utilizing the TRS configuration in the SIBx message. The synchronizing controller (104) is further configured to synchronize with the network node by utilizing the SSB when the schedule information indication of the SIBx message is not present in the SIB1.

The synchronizing controller (104) is configured to demand at least one of the SIBx message and the SIBx segments from the network node when the schedule information indication is not present in the SIB1. The synchronizing controller (104) is further configured to access at least one of the SIBx message and the SIBx segments when the schedule information indication is present in the SIB1.

The synchronizing controller (104) is configured to receive a segment of the SIBx message from the broadcast of the network node; wherein the segment of the SIBx message includes a part of the SIBxmessage; wherein a tag value of the SIBx is present in the SIB1. The synchronizing controller (104) is further configured to determine whether the SIBx segment is associated with a previous SIBx based on the tag value of the SIBx present in the SIB1. The synchronizing controller (104) is further configured to discard stored SIBx segments when the SIBx segment is associated with the previous SIBx based on the tag value of the SIBx present in the SIB1. The synchronizing controller (104) is further configured to store the SIBx segment of the SIBx message in a storage when the SIBx segment is not associated with the previous SIBx based on the tag value of the SIBx present in the SIB1. The synchronizing controller (104) is further configured to determine whether all segments of the SIBx message are received in the storage. The synchronizing controller (104) is further configured to assemble the all segments of the SIBx message when all segments of the SIBx message are received in the storage.

The synchronizing controller (104) is configured to determine an occurrence of a cell selection or a cell reselection. The synchronizing controller (104) is further configured to determine whether the cell selection or the cell reselection is to a target cell that is different than that of a serving cell. The synchronizing controller (104) is further configured to discard the stored SIBx segments when the cell selection or the cell reselection is to the target cell that is different than that of a serving cell.

The synchronizing controller (104) is configured to determine an occurrence of a cell selection or a cell reselection. The synchronizing controller (104) is further configured to determine whether the cell selection or the cell reselection is to a target cell whose area scope is different than the area scope of a serving cell. The synchronizing controller (104) is further configured to discard the stored SIBx segments when the cell selection or the cell reselection is to the target cell whose area scope is different than the area scope of the serving cell. The synchronizing controller (104) is further configured to keep the stored SIBx segments when the cell selection or the cell reselection is to the target cell whose area scope is not different than the area scope of the serving cell. The synchronizing controller (104) is further configured to discard the stored SIBx segments when the target cell is not supporting the TRS configuration or the schedule information for the SIBx is not present in the SIBI when the cell selection or the cell reselection is to the target cell whose area scope is not different than the area scope of the serving cell.

The synchronizing controller (104) is configured to determine a change in the IDLE state of the UE (100). The synchronizing controller (104) is further configured to initiate a Radio Resource Control (RRC) connection by sending a RRC setup request to the network node. The synchronizing controller (104) is further configured to receive a connection setup message in response to the RRC setup request and transit to the CONNECTED state from the IDLE state using the connection setup message. The synchronizing controller (104) is further configured to discard the stored SIBx segments when the UE (100) transits state to the CONNECTED state from the IDLE state.

The synchronizing controller (104) is configured to determine a change in the INACTIVE state of the UE (100) and resume the Radio Resource Control (RRC) connection by sending a RRC resume request to the network node. The synchronizing controller (104) is further configured to receive a RRC resume message in response to the RRC resume request. The synchronizing controller (104) is further configured to transit to the CONNECTED state from the INACTIVE state using the RRC resume message. The synchronizing controller (104) is further configured to discard the stored SIBx segments when the UE (100) transits state to the CONNECTED state from the INACTIVE state.

The synchronizing controller (104) is configured to detect whether any transition of the UE (100) to the CONNECTED state from one of the INACTIVE state or IDLE state. The synchronizing controller (104) is further configured to perform one of stop accessing and stop receiving SIBx segments in the CONNECTED state when any transition of the UE (100) to the CONNECTED state from one of the INACTIVE state or IDLE state.

The synchronizing controller (104) is configured to synchronize the UE (100) with the network node includes at least one of time synchronization, frequency synchronization, gain synchronization and Radio resource management (RRM) measurements.

The synchronizing controller (104) is configured to discard the stored SIBx segments or discontinues using the TRS configuration in the received SIBx message when at least one of the availability indication for the TRS configuration is unavailable and the validity duration of the TRS configuration is elapsed.

For power saving purpose of the UEs which are in IDLE state or INACTIVE state, network may reuse the reference signals e.g. TRS/CSIRS which are typically transmitted to CONNECTED state UEs. With these reference signals, UEs can perform at least one of time synchronization, frequency synchronization, gain control/synchronization or Radio Resource Management (RRM) measurements more effectively than the legacy SSB based operations in IDLE state or INACTIVE state. This results in better power saving for the UEs.

In an embodiment, only TRS configurations may be provided. For the sake of generality, the disclosure uses the term TRS/CSIRS, which means at least one of TRS only, CSIRS only or a combination of TRS and CSIRS.

In an embodiment, TRS/CSIRS reference signals configuration is broadcasted to the UEs. A new SIB (termed as SIBx) is used to carry the TRS/CSIRS configurations. Due to large number of configurations and also each configuration consisting of many parameters, the resultant size of the configuration information in the SIBx can be huge and may also exceed the size of the maximum SIB message (e.g. maximum SI message size allowed can be 2976 bits). Consequently, when needed, configuration information in the SIBx is split and provided to the UEs.

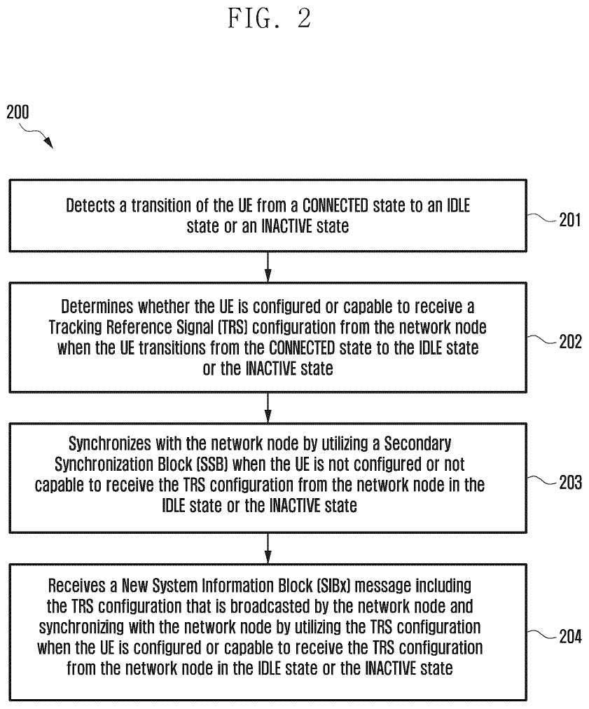

FIG. 2 is a flow chart (200) illustrating a method for performing synchronization of the UE (100) with the network node, according to an embodiment as disclosed herein.

At step 201, the UE (100) detects the transition of the UE (100) from the CONNECTED state to the IDLE state or the INACTIVE state.

At step 202, the UE (100) determines whether the UE (100) is configured or capable to receive the TRS configuration from the network node when the UE (100) transition from the CONNECTED state to the IDLE state or the INACTIVE state.

At step 203, the UE (100) synchronizes with the network node by utilizing the SSB when the UE (100) is not configured or not capable to receive the TRS configuration from the network node in the IDLE state or the INACTIVE state.

At step 204, the UE (100) receives the SIBx message including the TRS configuration that is broadcasted by the network node and synchronize with the network node by utilizing the TRS configuration when the UE (100) is configured or capable to receive the TRS configuration from the network node in the IDLE state or the INACTIVE state.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the disclosure.

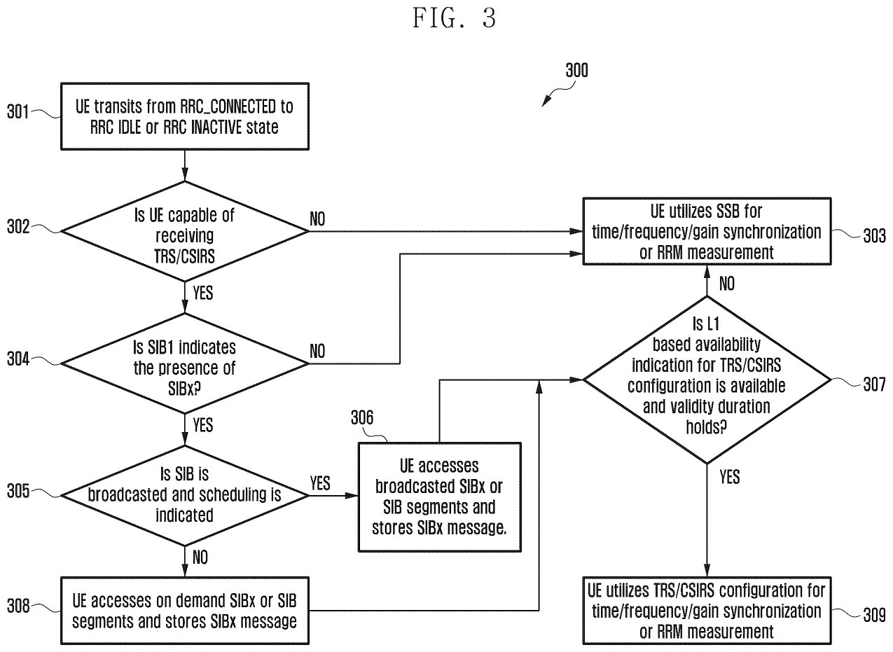

FIG. 3 is a flow chart (300) illustrating an overall process in synchronizing the UE (100) with the network node, according to an embodiment as disclosed herein.

At step 301, the UE (100) detects the transition of the UE (100) from the CONNECTED state to the IDLE state or the INACTIVE state.

At step 302, the UE (100) determines whether the UE (100) is configured and/or capable of receiving the TRS/CSIRS in the IDLE state or INACTIVE state. In an embodiment, the UE (100) determines whether to receive TRS/CSIRS in IDLE or INACTIVE for better power efficiency.

At step 303, the UE (100) synchronize with the network node by utilizing the SSB when the UE (100) is not configured or not capable to receive the TRS configuration from the network node in the IDLE or INACTIVE state.

At step 304, the UE (100) determines whether the SIBI indicates the presence of the SIBx. If the SIBx is not present, then the UE (100) utilizes the SSB for time/frequency/gain synchronization or RRM measurement.

At step 305, the UE (100) determines whether the SIBx is broadcasted and scheduling is indicated.

At step 306, the UE (100) accesses broadcasted SIBx or SIB segments and stores SIBx message.

At step 307, the UE (100) determines whether LI based availability indication for TRS/CSIRS configuration is available and validity duration holds.

At step 308, the UE (100) accesses on demand SIBx or SIB segments and stores SIBx message.

At step 309, the UE (100) utilizes the TRS/CSIRS configuration for time/frequency/gain synchronization or RRM measurement.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the disclosure.

In an embodiment, when the UE (100) transits from CONNECTED state to IDLE state e.g. when UE (100) receives RRC release message from network, expiry of data inactivity timer, requested by upper layer. or when the UE (100) transits from CONNECTED state to INACTIVE state (e.g. when UE (100) receives RRC Release with suspend configuration) and if the UE (100) is configured and/or capable of reception of TRS/CSIRS in IDLE state or INACTIVE state and/or UE (100) determines to receive TRS/CSIRS in IDLE state or INACTIVE state (e.g. for better power efficiency) and SIB1 indicates the presence of SIBx (e.g. broadcasted and scheduling is indicated or available on demand), accordingly the UE (100) starts accessing and storing the SIBx segments.

In an embodiment, if the UE (100) has stored SIBx message and the L1 based availability indication for TRS/CSIRS configuration has changed to “unavailable”, the UE (100) discards the stored SIBx message.

In another embodiment, if the UE (100) has stored SIBx message and the L1 based availability indication for specific TRS/CSIRS configuration (e.g. indicated by a relevant i'th indication bit in TRS/CSIRS availability indication field in DCI) which is relevant to the UE (100) (or UE (100) is utilizing this specific TRS/CSIRS configuration) has changed to “unavailable” (or validity of TRS/CSIRS configuration has expired), the UE (100) discards the stored SIBx message and avails SIBx again. Alternatively, UE (100) discontinues using the TRS/CSIRS configuration(s) in the stored SIBx message (i.e. not discard the stored SIBx message), which is indicated as “unavailable” (or validity of TRS/CSIRS configuration has expired) and/or UE (100) may start utilizing another TRS/CSIRS configuration present in stored SIBx message, which is not indicated to be “unavailable” (or which is indicated as “available”).

In an embodiment, UE (100) preserves the SIBx message (i.e. does not discard SIBx message) and maintains the availability/unavailability status for each of the TRS/CSIRS configurations present in the stored SIBx message and determines at least one suitable TRS/CSIRS configuration to use among the TRS/CSIRS configurations which are present with status as “available”. If the used TRS/CSIRS configuration becomes “unavailable” (or validity of TRS/CSIRS configuration has expired), UE (100) starts utilizing another suitable TRS/CSIRS configuration present in stored SIBx message, which is “available”. Suitability determination may be based on the occasion of TRS/CSIRS with respect to the paging occasion of the UE (100) or any other parameters of the TRS/CSIRS configuration. If UE (100) finds no suitable TRS/CSIRS present in stored SIBx message, UE (100) may start to utilize the SSB based approach to perform time/frequency/gain synchronization or RRC measurements. In an embodiment, if the UE (100) has stored SIBx message and the TRS/CSIRS configuration has changed, the UE (100) discards the stored SIBx message.

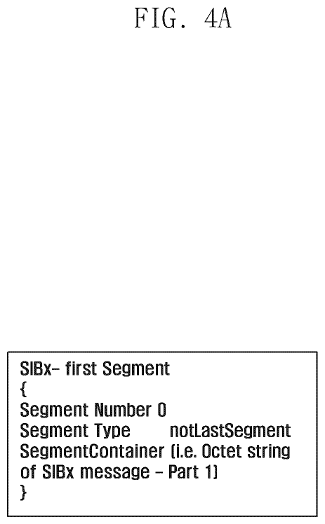

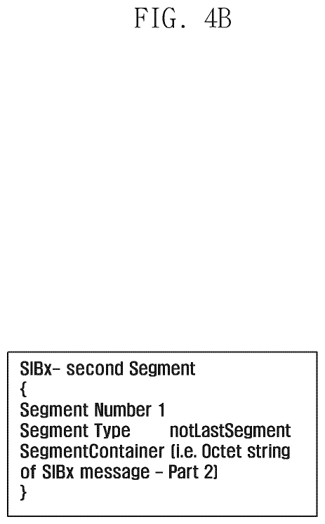

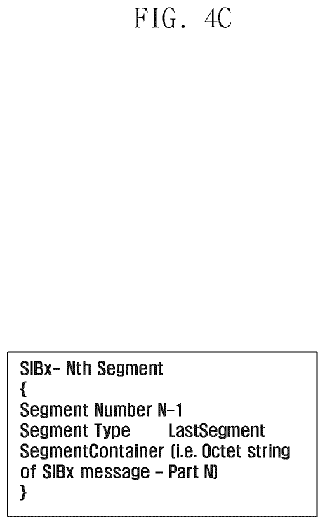

FIGS. 4A-4C are schematic diagrams illustrating a segments of a SIBx message containing an octet string, according to an embodiment as disclosed herein.

In an embodiment, the SIBx which carries the TRS/CSIRS configuration is segmented when the size of the TRS/CSIRS configuration exceeds the maximum allowed SIB size (e.g. 2976 bits). TRS/CSIRS configuration in the segmented SIBx is provided in one of the below approach:

Referring to FIGS. 4A-4C, the Approach is when a overall TRS/CSIRS configuration message (or payload) is segmented such that the first portion/part of the message is fitted to first SIBx segment, second portion of the message to the second SIBx segment and so on. Each portion of the message can be byte (or octet, i.e. 8 bits) aligned.

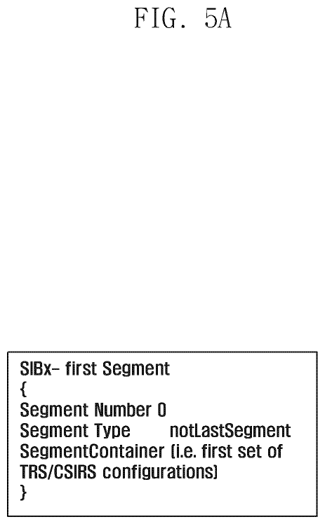

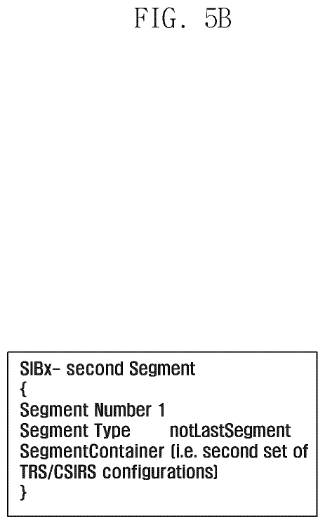

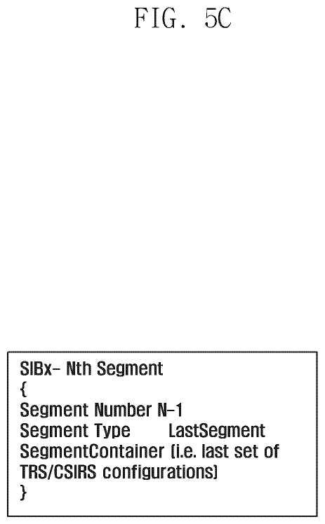

FIGS. 5A-5C are schematic diagrams illustrating a segments of the SIBx message containing a TRS configuration, according to an embodiment as disclosed herein.

Referring to FIGS. 5A-5C, when a TRS/CSI configuration message is segmented such that first set of TRS/CSIRS configurations are fitted to the first SIBx segment, second set of TRS/CSIRS configurations to the second SIBx segment and so on.

In an embodiment, the SIBx which carries the TRS/CSIRS configuration is segmented and each segment of the SIBx carries an identifier for the segment number (e.g. starts from 0 onwards and can be maximum as 63) and an identifier to indicate whether this segment is the last segment of the SIBx or not the last segment of the SIBx.

In an embodiment, when SIBx is not segmented (e.g. SIBx size lesser than or equal to the maximum allowed SI size), then one of the approaches as listed is utilized: SIBx message does not contain the identifiers for “segment number” and for indication of “last segment or not”. Absence of the identifiers is interpreted as SIBx is not segmented. In another embodiment, SIBx message contains the identifier for segment number set as 0 and/or identifier for indication of “last segment or not” set as last segment.

In an embodiment, when SIBx is not segmented while ensuring by the network to include minimum possible TRS/CSIRS configuration that are required to support IDLE/INACTIVE UEs and can also be fit in the maximum possible SIB size allowed (e.g. 2976 bits). For this purpose, a sub-set of the CONNECTED state TRS/CSIRS configurations are included in the SIBx. The reduction can be done with reducing the overall number of TRS/CSIRS configurations (or TRS/CSIRS resources) provided in the SIBx and/or with reducing the parameters of the specific TRS/CSIRS configurations provided in the SIBx (e.g. frequency domain allocation bits can be reduced) and/or efficient coding of the parameters to save required bits and/or compression of the contents for the TRS/CSIRS configurations and/or accommodating TRS/CSIRS configurations in two SIBs e.g. SIBx and SIBy, wherein SIBy is only broadcasted when SIBx is not able to accommodate all the TRS/CSIRS configurations and if so, then remaining of the TRS/CSIRS configurations are provided by SIBy.

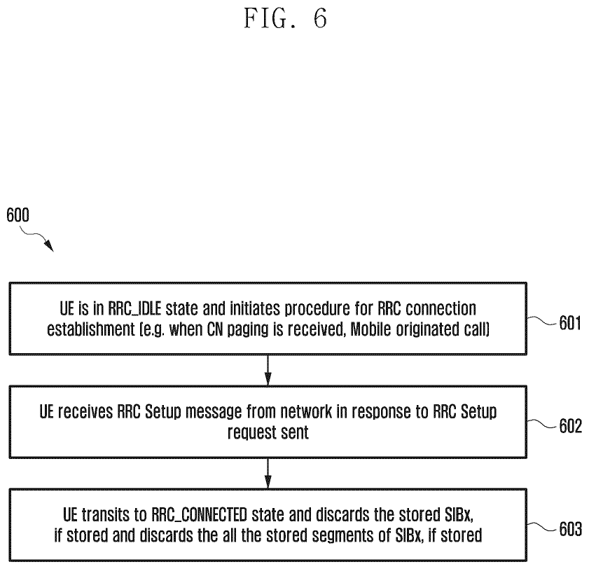

FIG. 6 is a flow chart (600) illustrating a method involved after transition of UE (100) to a CONNECTED state from an IDLE state, according to an embodiment as disclosed herein.

At step 601, the UE (100) is in the IDLE state and initiates procedure for RRC connection establishment e.g. when CN paging is received, Mobile originated call etc.

At step 602, the UE (100) receives RRC Setup message from network in response to RRC Setup request sent.

At step 603, the UE (100) transits to CONNECTED state and discards the stored SIBx, if stored and discards the all the stored segments of SIBx, if stored.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the disclosure.

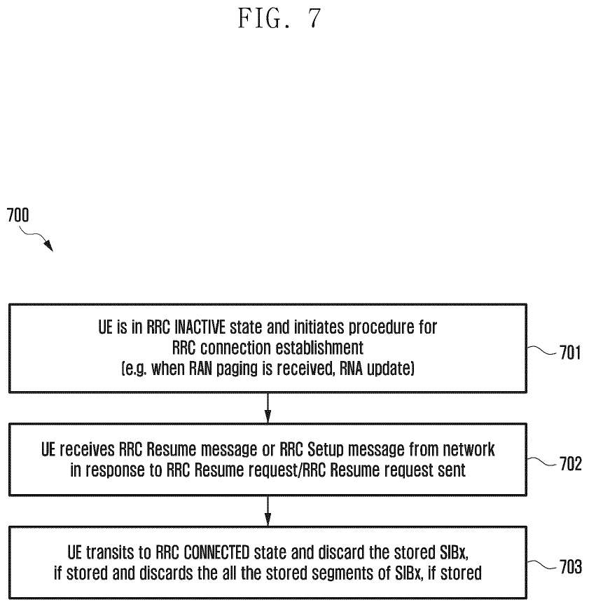

FIG. 7 is a flow chart (700) illustrating a method involved after transition of UE (100) to the CONNECTED state from the INACTIVE state, according to an embodiment as disclosed herein.

At step 701, the UE (100) is in INACTIVE state and initiates procedure for RRC connection establishment (e.g. when RAN paging is received, RNA update).

At step 702, the UE (100) receives RRC Resume message or RRC Setup message from network in response to RRC Resume request/RRC Resume request sent.

At step 703, the UE (100) transits to CONNECTED state and discard the stored SIBx, if stored and discards the all the stored segments of SIBx, if stored.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the disclosure.

In an embodiment, if the UE (100) has stored SIBx message and UE (100) transits from IDLE state to CONNECTED state or UE (100) transits from INACTIVE state to CONNECTED state, the UE (100) discards the stored SIBx message. The UE (100) may initiate the procedure for RRC connection establishment, when upper layers request establishment or resume of an RRC connection while the UE (100) is in IDLE state (e.g. CN paging is received, mobile originated call) or when upper layers request resume of an RRC connection or RRC layer requests resume of an RRC connection for, e.g. RNAU or reception of RAN paging while the UE (100) is in INACTIVE state. In IDLE state, UE (100) receives RRC Setup message from network in response to RRC Setup request sent. In INACTIVE state, UE (100) receives RRC Resume message or RRC Setup message from network in response to RRC Resume request/RRC Resume request 1 sent. Further, UE (100) may transit to CONNECTED state upon successful completion of the procedure. UE (100) discards the SIBx. Also, UE (100) stops accessing or receiving SIBx in the CONNECTED state. Below are provided are a few example specifications, given for just illustration purpose but not limiting in any manner, for the different conditions and triggers for the discard of the SIBx.

In an embodiment, the reception of the RRCConnectionSetup by the UE (100) is provided below:

The UE (100) shall:

1>except when the UE (100) connected to 5GC is a BL UE (100) or UE (100) in CE, if the RRCConnectionSetup is received in response to an RRCConnectionRe-sumeRequest from a suspended RRC connection:
2>if the UE (100) is resuming an RRC connection after early security reactivation in accordance with conditions in 5.3.3.18:
   3>discard any current AS security context including the KRRCene key, the KRRCint key, the KuPint key and the KuPene key;
2>release all radio resources, including release of the RLC entity, the MAC configuration and the associated PDCP entity for all established or suspended RBs, except for SRB0;
2>discard the stored UE (100) AS context and resume Identity;
2>if stored, discard the stored SIBx;
2>if stored, discard the stored nextHopChainingCount;
2>if stored, discard the stored drb-ContinueROHC;
2>indicate to upper layers fallback of the RRC connection;

1>if the RRCConnectionSetup is received in response to an RRCConnectionResumeRequest from INACTIVE:
2>stop T380 if running;
2>discard the stored UE (100) Inactive AS context;
2>if stored, discard the stored SIBx;
2>release rrc-InactiveConfig, if configured;

1>if the UE (100) connected to 5GC is a BL UE (100) or UE (100) in CE, and the RRCConnectionSetup is received in response to an RRCConnectionResumeRequest from a suspended RRC connection:
2>discard the stored UE (100) AS context and resumeIdentity;
2>if stored, discard the stored SIBx;
2>if stored, discard the stored nextHopChainingCount;
2>if stored, discard the stored drb-ContinueROHC;

In an another embodiment, an alternative of the reception of the RRCConnectionSetup by the UE (100) is provided below:

The UE (100) shall:

1>perform the radio resource configuration procedure in accordance with the received radioResourceConfigDedicated and as specified in 5.3.10;

1>if stored, discard the cell reselection priority information provided by the idleModeMobilityControlInfo or inherited from another RAT;

1>if stored, discard the altFreqPriorities provided by the RRCConnectionRelease;

1>if stored, discard the dedicated offset provided by the redirectedCarrierOffset Dedicated;

Further, the UE (100) shall:

1>enter CONNECTED;

1>if stored, discard the stored SIBx;

1>stop the cell re-selection procedure;

1>consider the current cell to be the PCell;

In an embodiment, the Reception of the RRCConnectionResume by the UE (100) is provided below:

The UE (100) shall:
2>else if resuming an RRC connection from INACTIVE:
   3>restore the following from the stored UE (100) Inactive AS context:
      MCG physical layer configuration,
      MCG MAC configuration,
      MCG RLC configuration,
      PDCP configuration;
   3>if restoreMCG-SCells is included:
      4>restore the MCG SCell(s) configuration, if stored;
   3>else:
      4>release the MCG SCell(s) from the UE (100) Inactive AS context, if stored;
   3>if restoreSCG is included:
      4>restore nr-SecondaryCellGroupConfig, if stored;
   3>else if the UE (100) was configured with NGEN-DC:
      4>perform MR-DC release, as specified in TS 38.331 [82], clause 5.3.5.10;
      4>release tdm-PatternConfig or tdm-PatternConfig2, if configured;
   3>discard the stored UE (100) Inactive AS context;
   3>if stored, discard the stored SIBx;
   3>configure lower layers to consider the restored MCG and SCG SCell(s) (if any) to be in deactivated state;
   3>release the rrc-InactiveConfig, except ran-NotificationAreaInfo;
2>else (i.e., except for NB-IOT for resuming a suspended RRC connection in 5GC):
   3>restore the physical layer configuration, the MAC configuration, the RLC configuration and the PDCP configuration from the stored UE (100) AS context;
   3>discard the stored UE (100) AS context and resumeIdentity;
   3>if stored, discard the stored SIBx;

In an another embodiment, an alternative of the reception of the RRCConnectionResume by the UE (100) is provided below:

The UE (100) shall:

1>if stored, discard the cell reselection priority information provided by the idleModeMobilityControlInfo or inherited from another RAT;

1>if stored, discard the altFreqPriorities provided by the RRCConnectionRelease;

1>if stored, discard the dedicated offset provided by the redirectedCarrierOffsetDedicated;

Further, the UE (100) shall:

1>enter CONNECTED;

1>if stored, discard the stored SIBx;

1>indicate to upper layers that the suspended RRC connection has been resumed;

1>stop the cell re-selection procedure;

1>consider the current cell to be the PCell;

In an embodiment, the UE does not discard the stored SIBx and/or the stored segments of SIBx while transiting to the CONNECTED state from IDLE state or INACTIVE state. In the CONNECTED state does not access or receive the SIBx and/or segments of SIBx. When UE again transits to the IDLE state or the INACTIVE state from the CONNECTED state (e.g. when receiving RRC connection release, RRC connection release with suspendconfig or RRC connection release with redirection, data inactivity timer expiry etc.), the UE performs at least one of the following:

(a) UE discards the stored SIBs and/or the stored segments of the SIBx.

(b) UE performs cell selection/reselection and if the cell selected/reselected (or the areascope of the cell selected/reselected) is the same as the serving cell, UE checks for the validity and/or value tag for the SIBx and accordingly, preserves the stored SIBx and/or stored segment of SIBx when validity and/or value tag holds or discards the stored SIBx and/or stored segment of SIBx when validity and/or value tag does not hold. If the cell selected/reselected (or the areascope of the cell selected/reselected) is the different than the serving cell, discards the stored SIBx and/or stored segment of SIBx.

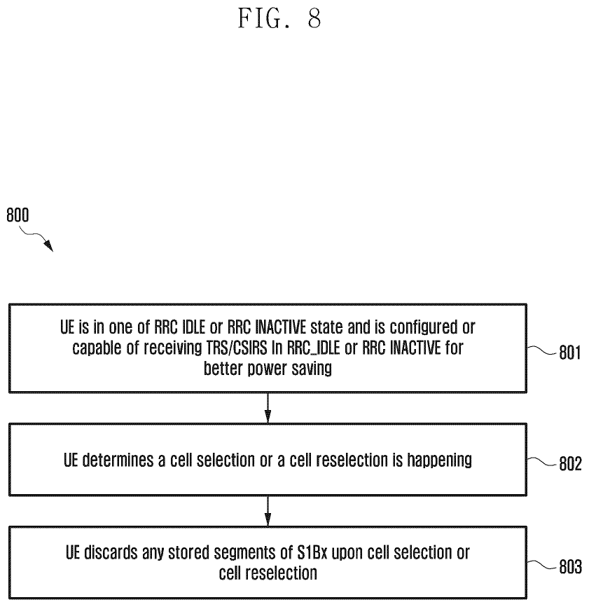

FIG. 8 is a flow chart (800) illustrating a method of discarding stored segments when determining a cell selection or a cell reselection, according to an embodiment as disclosed herein.

At step 801, the UE (100) is in one of IDLE or INACTIVE state and is configured or capable of receiving TRS/CSIRS in IDLE or INACTIVE for better power saving.

At step 802, the UE (100) determines the cell selection or the cell reselection is happening.

At step 803, the UE (100) discards any stored segments of SIBx upon cell selection or cell reselection.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the disclosure.

In an embodiment, if the UE (100) has stored at least one segment of the SIBx and UE (100) performs a cell selection or a cell reselection since a previous segment was stored, the UE (100) discards all the stored segments of the SIBx.

In an embodiment, if the UE (100) has stored at least one segment of the SIBx and UE (100) performs a cell selection or a cell reselection to a cell, whose area scope is not same as the previous serving cell, since a previous segment was stored, the UE (100) discards all the stored segments of the SIBx.

In an embodiment, if the UE (100) has stored at least one segment of the SIBx and UE (100) performs a cell reselection to a cell not supporting TRS/CSIRS configuration or the scheduling information for the SIBx is no longer present in the SIBI of the selected cell or reselected cell since a previous segment was stored, the UE (100) discards all the stored segments of the SIBx.

In an embodiment, if the UE (100) has stored at least one segment of the SIBx and the scheduling information for the SIBx is no longer present in the SIBI of the serving cell since a previous segment was stored, the UE (100) discards all the stored segments of the SIBx.

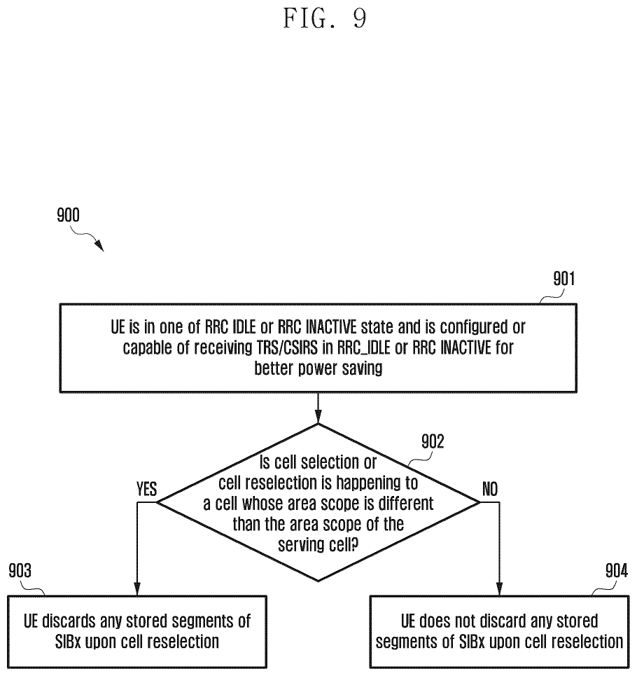

FIG. 9 is a flow chart (900) illustrating a method of discarding the stored segments when determining the cell selection or cell reselection to a cell whose are scope is different than the area scope of the serving cell, according to an embodiment as disclosed herein.

At step 901, the UE (100) is in one of IDLE or INACTIVE state and is configured or capable of receiving TRS/CSIRS in IDLE or INACTIVE for better power saving.

At step 902, the UE (100) determines whether cell selection or cell reselection is happening to a cell whose area scope is different than the area Scope of the serving cell.

At step 903, the UE (100) discards any stored segments of SIBx upon cell selection or cell reselection.

At step 904, the UE (100) does not discard any stored segments of SIBx upon cell selection or cell reselection.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the disclosure.

In an embodiment, if the UE (100) has stored SIBx message and UE (100) performs a cell selection or a cell reselection, the UE (100) discards the stored SIBx message.

In an embodiment, if the UE (100) has stored SIBx message and UE (100) performs a cell selection or a cell reselection to a cell, whose area scope is not same as the previous serving cell, the UE (100) discards the stored SIBx message.

In an embodiment, if the UE (100) has stored SIBx message and UE (100) performs a cell selection or a cell reselection to a cell not supporting TRS/CSIRS configuration or the scheduling information for the SIBx is no longer present in the SIBI of the selected cell or reselected cell, the UE (100) discards the stored SIBx message.

In an embodiment, if the UE (100) has stored SIBx message and the scheduling information for the SIBx is no longer present in the SIBI of the serving cell, the UE (100) discards the stored SIBx message.

In an embodiment, one or more combinations of the aforementioned conditions is considered by the UE (100), when UE (100) discards the stored SIBx message. Below is provided an example specification, given for just illustration purpose but not limiting in any manner, for the different conditions and triggers for the discard of the stored SIBx message.

In an embodiment, the discarding of the stored SIBx message in a list of scenarios are provided below:

The UE (100) shall:

1>if the UE (100) has stored SIBx message and the value tag of SIBx has changed; or

1>if the UE (100) has stored SIBx message and the TRS/CSIRS configuration has changed; or

1>if the UE (100) has stored SIBx message and the availability indication for TRS/CSIRS configuration has changed to “unavailable”:

2>discard the stored SIBx message.

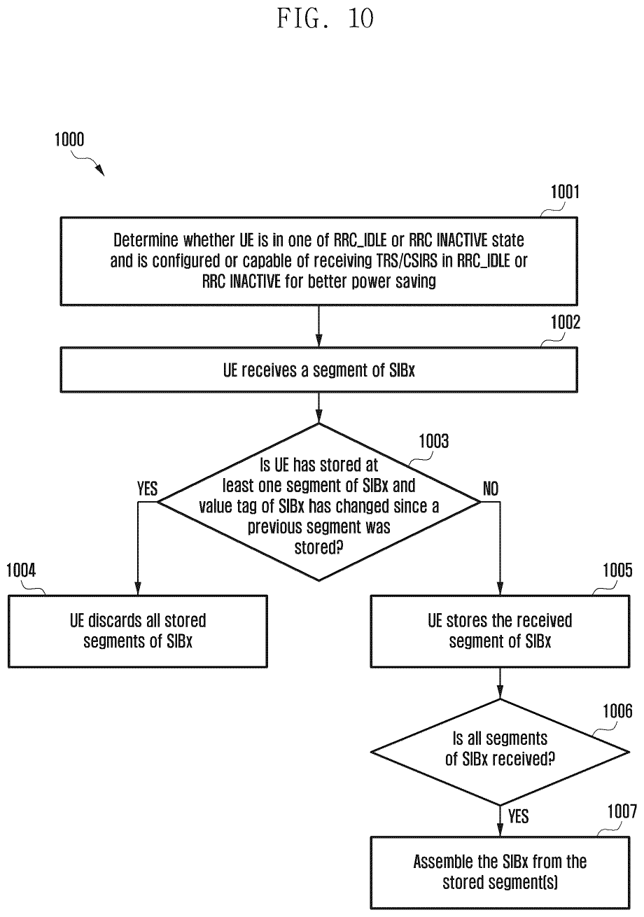

FIG. 10 is a flow chart (1000) illustrating a method of assembling the SIBx message from the stored segments, according to an embodiment as disclosed herein.

At step 1001, the UE (100) is in one of IDLE or RRC INACTIVE state and is configured or capable of receiving TRS/CSIRS in IDLE or RRC INACTIVE for better power saving

At step 1002, the UE (100) receives a segment of SIBx

At step 1003, the UE (100) determines whether the UE (100) has stored at least onesegment of SIBx and value tag of SIBx has changed since a previous segment was stored?

At step 1004, the UE (100) discards all stored segments of SIBx

At step 1005, the UE (100) stores the received segment of SIBx.

At step 1006, UE (100) determines whether all segments of SIBx are received.

At step 1007, on determining that all segments of SIBx are received, UE (100) assembles the SIBx from the stored segment(s).

In an embodiment, dedicated broadcast HARQ process is used for receiving segmented SIBx. There can be transmission of SIBx segments one after another (e.g. in SI window) and then it may be followed by repetitions of the segments in the same modification window, HARQ process considers each segment reception as new transmission and delivers to the upper layer, when decoding is successful. Otherwise, when decoding is not successful, HARQ process clears the HARQ buffer before receiving another segment. When all the segments of SIBx are received, when informed by the upper layer, HARQ process can halt the reception of SIBx or SIB segment in the same modification window. When informed by upper layer (e.g. when there is a change in TRS/CSIRS configuration, L1 signaling based availability status for SIBx changes, value Tag for SIBx changes), HARQ process can further resume reception of SIBx or SIBx segment.

In an embodiment, if the UE (100) has stored SIBx message and a value tag of SIBx has changed, the UE (100) discards the stored SIBx message.

In an embodiment, when SIBx is not segmented (e.g. when segment number is 0 and “last segment” is set), HARQ process can perform combining of the received transmission with its retransmission (or repletion) in the same modification window to enhance reliability performance. That is, HARQ process does not clear the HARQ buffer when decoding is not successful in the first transmission of SIBx in the modification window.

In an embodiment, SIBx segments are stored (e.g. in a defined buffer or memory). Further, UE (100) performs detection for duplicate reception of any segment and discard of duplicate segment, reordering of the segments when received out of order and assembling of the SIBx message from the received segments of SIBx. The operation is performed with the aid of the identifiers present in the SIBx segments i.e. “segment number” and/or “last segment or not”.

In an embodiment, if the UE (100) has stored at least one segment of the SIBx and the value tag of SIBx has changed since a previous segment was stored, the UE (100) discards all the stored segments of the SIBx.

In an embodiment, if the UE (100) has stored at least one segment of the SIBx and the L1 based availability indication for TRS/CSIRS configuration has changed to “unavailable” since a previous segment was stored, the UE (100) discards all the stored segments of the SIBx. In another embodiment, LI based availability indication for TRS/CSIRS configuration may also be “unavailable” for all the indication bits i.e. no TRS/CSIRS configuration is available or validity duration for L1 based availability indication for TRS/CSIRS configuration has expired.

In an embodiment, the UE (100) discards any stored segments for SIBx if the complete SIBx has not been assembled within a validity period e.g. a period of 3 hours.

In an embodiment, if the UE (100) has stored at least one segment of the SIBx and the L1 based availability indication for TRS/CSIRS configuration has changed to “unavailable” since a previous segment was stored, the UE (100) does not discard all the stored segments of the SIBx and UE (100) continues receiving and storing SIBx segments.

In an embodiment, if the UE (100) has stored at least one segment of the SIBx and the TRS/CSIRS configuration has changed since a previous segment was stored, the UE (100) discards all the stored segments of the SIBx.

In an embodiment, one or more combinations of the aforementioned conditions is considered by the UE (100), when UE (100) discards all the stored segments of the SIBx. Below are provided are a few example specifications, given for just illustration purpose but not limiting in any manner, for the different conditions and triggers for the discard of all the segments of the SIBx.

In an embodiment, upon receiving SIBx, the UE (100) performs below: The UE (100) shall:

1>if the UE (100) has stored at least one segment of SIBx and the value tag of SIBx has changed since a previous segment was stored; or

1>if the UE (100) has stored at least one segment of SIBx and the L1 based availability indication for TRS/CSIRS configuration has changed to “unavailable” since a previous segment was stored:
2>discard all stored segments;

1>store the segment;

1>if all segments have been received:
2>assemble SIBx-IEs from the received segments.

In an another embodiment, an alternative of the upon receiving SIBx, the UE (100) performs below:

The UE (100) shall:

1>if the UE (100) has stored at least one segment of SIBx and the TRS/CSIRS configuration has changed since a previous segment was stored;
2>discard all stored segments;

1>store the segment;

1>if all segments have been received:
assembleSIBx-IEs from the received segments.

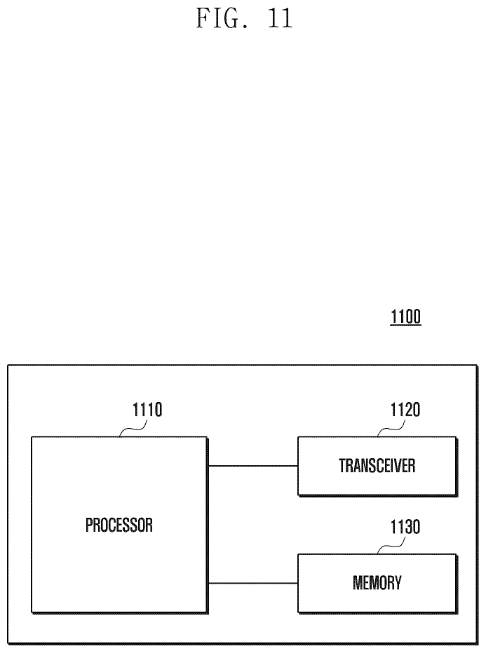

FIG. 11 is an electronic device according to an embodiment as disclosed herein. Referring to the FIG. 11, the electronic device 1100 may include a processor 1110, a transceiver 1120 and a memory 1130. However, all of the illustrated components are not essential. The electronic device 1100 may be implemented by more or less components than those illustrated in FIG. 11. In addition, the processor 1110 and the transceiver 1120 and the memory 1130 may be implemented as a single chip according to another embodiment.

The electronic device 1100 may correspond to the UE described above.

The aforementioned components will now be described in detail.

The processor 1110 may include one or more processors or other processing devices that control the proposed function, process, and/or method. Operation of the electronic device 1100 may be implemented by the processor 1110.

The transceiver 1120 may include a RF transmitter for up-converting and amplifying a transmitted signal, and a RF receiver for down-converting a frequency of a received signal. However, according to another embodiment, the transceiver 1120 may be implemented by more or less components than those illustrated in components.

The transceiver 1120 may be connected to the processor 1110 and transmit and/or receive a signal. The signal may include control information and data. In addition, the transceiver 1120 may receive the signal through a wireless channel and output the signal to the processor 1110. The transceiver 1120 may transmit a signal output from the processor 1110 through the wireless channel.

The memory 1130 may store the control information or the data included in a signal obtained by the electronic device 1100. The memory 1130 may be connected to the processor 1110 and store at least one instruction or a protocol or a parameter for the proposed function, process, and/or method. The memory 1130 may include read-only memory (ROM) and/or random access memory (RAM) and/or hard disk and/or CDROM and/or DVD and/or other storage devices.

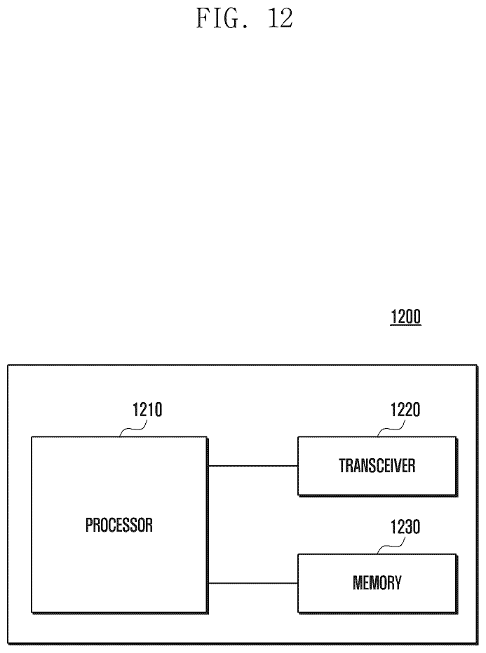

FIG. 12 is an electronic device according to an embodiment as disclosed herein.

Referring to the FIG. 12, the base station 1200 may include a processor 1210, a transceiver 1220 and a memory 1230. However, all of the illustrated components are not essential. The base station 1200 may be implemented by more or less components than those illustrated in FIG. 12. In addition, the processor 1210 and the transceiver 1220 and the memory 1230 may be implemented as a single chip according to another embodiment.

The base station 1200 may correspond to the network node described above.

The aforementioned components will now be described in detail.

The processor 1210 may include one or more processors or other processing devices that control the proposed function, process, and/or method. Operation of the base station 1200 may be implemented by the processor 1210.

The transceiver 1220 may include a RF transmitter for up-converting and amplifying a transmitted signal, and a RF receiver for down-converting a frequency of a received signal. However, according to another embodiment, the transceiver 1220 may be implemented by more or less components than those illustrated in components.

The transceiver 1220 may be connected to the processor 1210 and transmit and/or receive a signal. The signal may include control information and data. In addition, the transceiver 1220 may receive the signal through a wireless channel and output the signal to the processor 1210. The transceiver 1220 may transmit a signal output from the processor 1210 through the wireless channel.

The memory 1230 may store the control information or the data included in a signal obtained by the base station 1200. The memory 1230 may be connected to the processor 1210 and store at least one instruction or a protocol or a parameter for the proposed function, process, and/or method. The memory 1230 may include read-only memory (ROM) and/or random access memory (RAM) and/or hard disk and/or CDROM and/or DVD and/or other storage devices.

According to an embodiment, a method for performing synchronization of a User Equipment (UE) (100) with a network node may provided.

According to an embodiment, the method may include detecting, by the UE (100), a transition of the UE (100) from a CONNECTED state to an IDLE state or an INACTIVE state.

According to an embodiment, the method may include determining, by the UE (100), whether the UE (100) is configured or capable to receive a Tracking Reference Signal (TRS) configuration from the network node when the UE (100) transitions from the CONNECTED state to the IDLE state or the INACTIVE state.

According to an embodiment, the method may include performing, by the UE (100), one of: synchronizing with the network node by utilizing a Secondary Synchronization Block (SSB) when the UE (100) is not configured or not capable to receive the TRS configuration from the network node in the IDLE state or the INACTIVE state. or receiving, by the UE (100), a New System Information Block (SIBx) message comprising the TRS configuration that is broadcasted by the network node and synchronizing with the network node by utilizing the TRS configuration when the UE (100) is configured or capable to receive the TRS configuration from the network node in the IDLE state or the INACTIVE state.

According to an embodiment, synchronizing with the network node by utilizing the TRS configuration when the UE (100) is configured or capable to receive the TRS configuration from the network node in the IDLE state or the INACTIVE state may include: storing, by the UE (100), the SIBx message that is received by the UE (100); determining, by the UE (100), whether an availability indication for the TRS configuration is present and a validity duration of the TRS configuration is not elapsed using the SIBx message; and synchronizing, by the UE (100), with the network node in the at least one of the IDLE state and the INACTIVE state when the availability status for the TRS configuration is present and the validity duration of the TRS configuration is not elapsed.

According to an embodiment, receiving, by the UE (100), the SIBx message comprising the TRS configuration that is broadcasted by the network node may include: receiving, by the UE (100), a System Information Block (SIB1) that is broadcasted by the network node; determining, by the UE (100), whether a schedule information indication of SIBx message is present in the SIB1; and performing, by the UE (100), one of: determining that the SIBx message is provided by a serving cell of the network node when the schedule information indication of the SIBx message is present in the SIB1; and synchronizing with the network node by utilizing the TRS configuration in the SIBx message; or synchronizing with the network node by utilizing the SSB when the schedule information indication of the SIBx message is not present in the SIB1.

According to an embodiment, wherein determining the SIBx message from the network node when the schedule information indication of the SIBx message is present in the SIBI may include: performing, by the UE (100), one of: demanding at least one of the SIBx message and the SIBx segments from the network node when the schedule information indication is not present in the SIB1; or accessing at least one of the SIBx message and the SIBx segments when the schedule information indication is present in the SIB1.

According to an embodiment, storing, by the UE (100), the SIBx message that is received by the UE (100) may include: receiving, by the UE (100), a segment of the SIBx message from the broadcast of the network node; wherein the segment of the SIBx message includes a part of the SIBx message; wherein a tag value of the SIBx is present in the SIB1; determining, by the UE (100), whether the SIBx segment is associated with a previous SIBx based on the tag value of the SIBx present in the SIB1; and performing, by the UE (100), one of: discarding the stored SIBx segments when the SIBx segment is associated with the previous SIBx based on the tag value of the SIBx present in the SIB1; or storing the SIBx segment of the SIBx message in a storage when the SIBx segment is not associated with the previous SIBx based on the tag value of the SIBx present in the SIB1; determining whether all segments of the SIBx message are received in the storage; and assembling the all segments of the SIBx message when all segments of the SIBx message are received in the storage.

According to an embodiment, the method may include: determining, by the UE (100), an occurrence of a cell selection or a cell reselection; determining, by the UE (100), whether the cell selection or the cell reselection is to a target cell that is different than that of the serving cell; and discarding, by the UE (100), the stored SIBx segments when the cell selection or the cell reselection is to the target cell that is different than that of a serving cell.

According to an embodiment, the method may include: determining, by the UE (100), whether the cell selection or the cell reselection is to a target cell whose area scope is different than the area scope of the serving cell; performing, by the UE (100), one of: discarding the stored SIBx segments when the cell selection or the cell reselection is to the target cell whose area scope is different than the area scope of the serving cell; keeping the stored SIBx segments when the cell selection or the cell reselection is to the target cell whose area scope is not different than the area scope of the serving cell; or discarding the stored SIBx segments when the target cell is not supporting the TRS configuration or the schedule information for the SIBx is not present in the SIBI when the cell selection or the cell reselection is to the target cell whose area scope is not different than the area scope of the serving cell.

According to an embodiment, the method may include: determining, by the UE (100), a change in the IDLE state of the UE (100); initiating, by the UE (100), a Radio Resource Control (RRC) connection by sending a RRC setup request to the network node; receiving, by the UE (100), a connection setup message in response to the RRC setup request; transiting, by the UE (100), to the CONNECTED state from the IDLE state using the connection setup message; and discarding, by the UE (100), the stored SIBx segments when the UE (100) transits state to the CONNECTED state from the IDLE state.

According to an embodiment, the method may include: determining, by the UE (100), a change in the INACTIVE state of the UE (100); resuming, by the UE (100), the Radio Resource Control (RRC) connection by sending a RRC resume request to the network node; receiving, by the UE (100), a RRC resume message in response to the RRC resume request; transiting, by the UE (100), to the CONNECTED state from the INACTIVE state using the RRC resume message; and discarding, by the UE (100), the stored SIBx segments when the UE (100) transits state to the CONNECTED state from the INACTIVE state.

According to an embodiment, the method may include: detecting, by the UE (100), whether any transition of the UE (100) to the CONNECTED state from one of the INACTIVE state or IDLE state; and performing, by the UE (100), one of stop accessing or stop receiving SIBx segments in the CONNECTED state when any transition of the UE (100) is to the CONNECTED state from one of the INACTIVE state or IDLE state.

According to an embodiment, synchronization of the UE (100) with the network node may include at least one of time synchronization, frequency synchronization, gain synchronization and Radio resource management (RRM) measurements.

According to an embodiment, the UE (100) may perform one of: discards the stored SIBx segments or discontinues using the TRS configuration in the received SIBx message when at least one of the availability indication for the TRS configuration is unavailable and the validity duration of the TRS configuration is elapsed.

According to an embodiment, the method may include: determining, by the network node, a size of the TRS configuration; identifying, by the network node, whether the size of the TRS configuration meets a threshold; performing, by the network node, one of: segmenting the TRS configuration when the size of the TRS configuration meets the threshold; sending the TRS configuration in the SIBx message without segmenting the TRS configuration when the size of the TRS configuration does not meet the threshold.

According to an embodiment, segmenting the TRS configuration when the size of the TRS configuration meets the threshold may include: fitting, by the network node, a first portion of the TRS configuration and an identifier of the first portion of the TRS configuration in a first segment of the SIBx message; fitting, by the network node, at least one second portion of the TRS configuration and an identifier of the at least one second portion of the TRS configuration in the at least one second segment of the SIBx message; wherein the identifier helps the UE (100) to identify a last segment of the SIBx message.

According to an embodiment, sending the TRS configuration in the SIBx message without segmenting the TRS configuration when the size of the TRS configuration not meets the threshold may include: performing, by the network node, one of: fitting the TRS configuration without an identifier in the SIBx message; or fitting the TRS configuration and a key identifier in the SIBx message; wherein the key identifier indicates that the SIBx message is without segmentation.

According to an embodiment, a User Equipment (UE) (100) for performing synchronization with a network node may be provided.

According to an embodiment, the UE (100) may include: a memory (101); a processor (102) coupled to the memory (101); and a synchronizing controller (104) coupled to the memory (101) and the processor (102).

According to an embodiment, the synchronizing controller (104) may be configured to: detect a transition of the UE (100) from a CONNECTED state to an IDLE state or an INACTIVE state; determine whether the UE (100) is configured or capable to receive a Tracking Reference Signal (TRS) configuration from the network node when the UE (100) transition from the CONNECTED state to the IDLE state or the INACTIVE state; and perform one of: synchronize with the network node by utilizing a Secondary Synchronization Block (SSB) when the UE (100) is not configured or not capable to receive the TRS configuration from the network node in the IDLE state or the INACTIVE state; or receive a New System Information Block (SIBx) message comprising the TRS configuration that is broadcasted by the network node and synchronize with the network node by utilizing the TRS configuration when the UE (100) is configured or capable to receive the TRS configuration from the network node in the IDLE state or the INACTIVE state.

According to an embodiment, when synchronizing with the network node by utilizing the TRS configuration when the UE (100) is configured or capable to receive the TRS configuration from the network node in the IDLE state or the INACTIVE state, the synchronizing controller (104) may be configured to: store the SIBx message that is received by the UE (100); determine whether an availability indication for the TRS configuration is present and a validity duration of the TRS configuration is not elapsed using the SIBx message; and synchronize with the network node in the at least one of the IDLE state and the INACTIVE state when the availability status for the TRS configuration is present and the validity duration of the TRS configuration is not elapsed.

According to an embodiment, when receiving the SIBx message comprising the TRS configuration that is broadcasted by the network node, the synchronizing controller (104) may be configured to: receive a System Information Block (SIB1) that is broadcasted by the network node; determine whether the schedule information indication of SIBx message is present in the SIB1; and perform one of: determine the SIBx message is provided by a serving cell of the network node when the schedule information indication of the SIBx message is present in the SIB1; and synchronizing with the network node by utilizing the TRS configuration in the SIBx message; or synchronize with the network node by utilizing the SSB when the schedule information indication of the SIBx message is not present in the SIB1.

According to an embodiment, when determining the SIBx message from the network node when the schedule information indication of the SIBx message is present in the SIB1, the synchronizing controller (104) may be configured to: perform one of: demand at least one of the SIBx message and the SIBx segments from the network node when the schedule information indication is not present in the SIB1; or access at least one of the SIBx message and the SIBx segments when the schedule information indication is present in the SIBI.

According to an embodiment, when storring the SIBx message that is received by the UE (100), the synchronizing controller (104) may be configured to: receive a segment of the SIBx message from the broadcast of the network node; wherein the segment of the SIBx message includes a part of the SIBx message; wherein a tag value of the SIBx is present in the SIB1; determine whether the SIBx segment is associated with a previous SIBx based on the tag value of the SIBx present in the SIB1; and perform one of: discard the stored SIBx segments when the SIBx segment is associated with the previous SIBx based on the tag value of the SIBx present in the SIB1; or store the SIBx segment of the SIBx message in a storage when the SIBx segment is not associated with the previous SIBx based on the tag value of the SIBx present in the SIB1;determine whether all segments of the SIBx message are received in the storage; and assemble the all segments of the SIBx message when all segments of the SIBx message are received in the storage.

According to an embodiment, wherein the synchronizing controller may be further configured to: determine an occurrence of a cell selection or a cell reselection;

determine whether the cell selection or the cell reselection is to a target cell that is different than that of the serving cell; and discard the stored SIBx segments when the cell selection or the cell reselection is to the target cell that is different than that of a serving cell.

According to an embodiment, wherein the synchronizing controller may be further configured to: determine an occurrence of a cell selection or a cell reselection; determine whether the cell selection or the cell reselection is to a target cell whose area scope is different than the area scope of a serving cell; perform one of: discard the stored SIBx segments when the cell selection or the cell reselection is to the target cell whose area scope is different than the area scope of the serving cell; keep the stored SIBx segments when the cell selection or the cell reselection is to the target cell whose area scope is not different than the area scope of the serving cell; or discard the stored SIBx segments when the target cell is not supporting the TRS configuration or the schedule information for the SIBx is not present in the SIB1 when the cell selection or the cell reselection is to the target cell whose area scope is not different than the area scope of the serving cell.

According to an embodiment, wherein the synchronizing controller may be further configured to: determine a change in the IDLE state of the UE (100); initiate a Radio Resource Control (RRC) connection by sending a RRC setup request to the network node; receive a connection setup message in response to the RRC setup request; transit to the CONNECTED state from the IDLE state using the connection setup message; and discard the stored SIBx segments when the UE (100) transits state to the CONNECTED state from the IDLE state.

According to an embodiment, wherein the synchronizing controller may be further configured to: determine a change in the INACTIVE state of the UE (100); resume the Radio Resource Control (RRC) connection by sending a RRC resume request to the network node; receive a RRC resume message in response to the RRC resume request; transit to the CONNECTED state from the INACTIVE state using the RRC resume message; and discard the stored SIBx segments when the UE (100) transits state to the CONNECTED state from the INACTIVE state.

According to an embodiment, wherein the synchronizing controller may be further configured to: detect whether any transition of the UE (100) to the CONNECTED state from one of the INACTIVE state or IDLE state; and perform one of stop accessing and stop receiving SIBx segments in the CONNECTED state when any transition of the UE (100) to the CONNECTED state from one of the INACTIVE state or IDLE state.

According to an embodiment, wherein synchronization of the UE (100) with the network node includes at least one of time synchronization, frequency synchronization, gain synchronization and Radio resource management (RRM) measurements.

According to an embodiment, wherein the UE (100) discards the stored SIBx segments or discontinues using the TRS configuration in the received SIBx message when at least one of the availability indication for the TRS configuration is unavailable and the validity duration of the TRS configuration is elapsed.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1.-15. (canceled)

16. A method performed by a user equipment (UE) in a communication system, the method comprising:
receiving a system information block (SIB) associated with a tracking reference signal (TRS), wherein the SIB incudes a segment number and a segment type;
identifying that the SIB includes a segment for the SIB corresponding to the segment number and the segment type; and
storing the received segment.

17. The method of claim 16,
wherein the segment is an N+1th segment for the SIB, where N is a value of the segment number which is a non-negative integer from 0 to 63, and
wherein the segment type indicates whether the segment is a last segment for the SIB or not.

18. The method of claim 16, further comprising:
in case that the UE has stored at least one segment for SIB and a value tag for the SIB is changed since a previous segment was stored, discarding the at least one stored segment.

19. The method of claim 16, further comprising:
in case that a cell selection or a cell reselection is performed, discarding stored segments of the SIB.

20. The method of claim 16, further comprising:
in case that all segments for the SIB is received, assembling the received segments; and
in case that the assembling is not performed within a predefined duration, discarding stored segments of the SIB.

21. The method of claim 16,
wherein a plurality of TRS configurations are configured based on the SIB,
wherein a layer-1 (L1) based availability indication field for a plurality of TRS configurations is received in downlink control information (DCI), and
wherein each TRS configuration is associated with each bit in the L1 based availability indication field.

22. A user equipment (UE) in a communication system, the UE comprising:
a transceiver; and
a processor coupled with the transceiver and configured to:
receive a system information block (SIB) associated with a tracking reference signal (TRS), wherein the SIB includes a segment number and a segment type;
identify that the SIB includes a segment for the SIB corresponding to the segment number and the segment type; and
store the received segment.

23. The UE of claim 22,
wherein the segment is an N+1th segment for the SIB, where N is a value of the segment number which is a non-negative integer from 0 to 63, and
wherein the segment type indicates whether the segment is a last segment for the SIB or not.

24. The UE of claim 22, wherein the processor is further configured to:
in case that the UE has stored at least one segment for SIB and a value tag for the SIB is changed since a previous segment was stored, discard the at least one stored segment.

25. The UE of claim 22, wherein the processor is further configured to:
in case that a cell selection or a cell reselection is performed, discard stored segments of the SIB.

26. The UE of claim 22, wherein the processor is further configured to:
in case that all segments for the SIB is received, assemble the received segments; and
in case that the assembling is not performed within a predefined duration, discard stored segments of the SIB.

27. The UE of claim 22,
wherein a plurality of TRS configurations are configured based on the SIB,
wherein a layer-1 (L1) based availability indication field for a plurality of TRS configurations is received in downlink control information (DCI), and
wherein each TRS configuration is associated with each bit in the L1 based availability indication field.

28. A method performed by a base station in a communication system, the method comprising:
obtaining segments for a system information block (SIB) associated with a tracking reference signal (TRS);
obtaining a segment number corresponding to a segment and a segment type corresponding to the segment; and
transmitting the SIB including the segment, the segment number and the segment type.

29. The method of claim 28,
wherein the segment is an N+1th segment for the SIB, where N is a value of the segment number which is a non-negative integer from 0 to 63, and
wherein the segment type indicates whether the segment is a last segment for the SIB or not.

30. The method of claim 28,
wherein a plurality of TRS configurations are configured based on the SIB,
wherein a layer-1 (L1) based availability indication field for a plurality of TRS configurations is transmitted in downlink control information (DCI), and
wherein each TRS configuration is associated with each bit in the LI based availability indication field.

31. A base station in a communication system, the base station comprising:
a transceiver; and
a processor coupled with the transceiver and configured to:
obtain segments for a system information block (SIB) associated with a tracking reference signal (TRS);
obtain a segment number corresponding to a segment and a segment type corresponding to the segment; and
transmit the SIB including the segment, the segment number and the segment type.

32. The base station of claim 31,
wherein the segment is an N+1th segment for the SIB, where N is a value of the segment number which is a non-negative integer from 0 to 63, and
wherein the segment type indicates whether the segment is a last segment for the SIB or not.

33 The base station of claim 31,
wherein a plurality of TRS configurations are configured based on the SIB,
wherein a layer-1 (L1) based availability indication field for a plurality of TRS configurations is transmitted in downlink control information (DCI). and
wherein each TRS configuration is associated with each bit in the L1 based availability indication field.
